(19) United States
(12) Patent Application Publication
(10) Pub. No.: US 2016/0353937 A1
(43) Pub. Date: Dec. 8, 2016

(54) Wheelchair bathing attachment

(71) Applicant: JoAnne Dunnom, Miami, FL (US)

(72) Inventor: JoAnne Dunnom, Miami, FL (US)

(21) Appl. No.: 15/172,911

(22) Filed: Jun. 3, 2016

Related U.S. Application Data
(60) Provisional application No. 62/171,381, filed on Jun. 5, 2015.

(51) Int. Cl. A47K 1/05; E03C 1/22; A47K 7/08; A61H 35/00

(52) U.S. Cl. CPC A47K 1/05; A61H 35/006; E03C 1/22; A47K 7/08; A61H 2203/0431

(57) ABSTRACT

A wheelchair bathing attachment provides four sections in an accordion fold, supporting the user's back, buttocks, lower legs, and feet in a sitting position on a wheelchair or scooter. Two small wash basins are provided for the buttocks and feet. Each wash basin provides a central drain with a removable, flexible drain hose, enabling the user to drain the used water conveniently into a sink or toilet. The attachment is provided in a range of configurations and sizes to fit any existing wheelchair or scooter.

### CROSS-REFERENCE TO RELATED APPLICATIONS

This application claims the benefit of U.S. Provisional Application No. 62/171,381, filed Jun. 5, 2015, which is hereby incorporated by reference.

### STATEMENT REGARDING FEDERALLY SPONSORED RESEARCH OR DEVELOPMENT

Not Applicable.

### PARTIES TO A JOINT RESEARCH AGREEMENT

Not Applicable.

### REFERENCE TO SEQUENCE LISTING, A TABLE, OR A COMPUTER PROGRAM LISTING COMPACT DISK APPENDIX

Not Applicable

### BACKGROUND OF THE INVENTION

The invention relates generally to home health care equipment and in particular to a wheelchair bathing attachment. For those individuals confined to a wheelchair, bathing is a major challenge. Personal hygiene is particularly important for such individuals, but physically it can be nearly impossible. Various large, costly, and cumbersome devices have been developed, but for so many on fixed incomes, these items are financially out of reach even if sufficient space could be found for them. Technology provides a solution. A wheelchair bathing attachment, which inexpensively provides two small wash basins in key locations and folds flat when removed from the user's wheelchair, would resolve this problem.

### SUMMARY OF THE INVENTION

Accordingly, the invention is directed to a wheelchair bathing attachment. The attachment provides four sections in an accordion fold, supporting the user's back, buttocks, lower legs, and feet in a sitting position on a wheelchair or scooter. Two small wash basins are provided for the buttocks and feet. Each wash basin provides a central drain with a removable, flexible drain hose, enabling the user to drain the used water conveniently into a sink or toilet. The attachment is provided in a range of configurations and sizes to fit any existing wheelchair or scooter.

Additional features and advantages of the invention will be set forth in the description which follows, and will be apparent from the description, or may be learned by practice of the invention. The foregoing general description and the following detailed description are exemplary and explanatory and are intended to provide further explanation of the invention.

### BRIEF DESCRIPTION OF THE DRAWINGS

The accompanying drawings are included to provide a further understanding of the invention and are incorporated into and constitute a part of the specification. They illustrate one embodiment of the invention and, together with the description, serves to explain the principles of the invention.

FIG. 1 is a right side view of the first exemplary embodiment, displaying the attachment 10, the headrest 11, the upper basin 12, the lower basin 13, and the drain hoses 15.

FIG. 2 is a front view of the first exemplary embodiment, displaying the attachment 10, the headrest 11, the upper basin 12, the lower basin 13, and the drains 14.

FIG. 3 is a rear view of the first exemplary embodiment, displaying the attachment 10, the headrest 11, and the drain hoses 15.

FIG. 4 is a left side view of the first exemplary embodiment, displaying the attachment 10, the headrest 11, the upper basin 12, the lower basin 13, and the drain hoses 15.

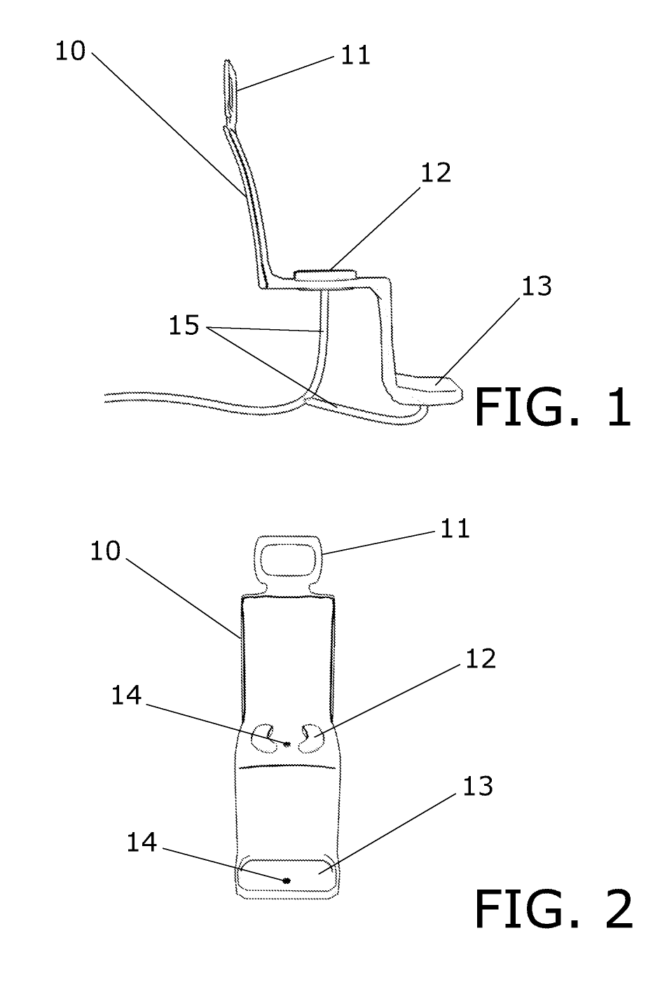

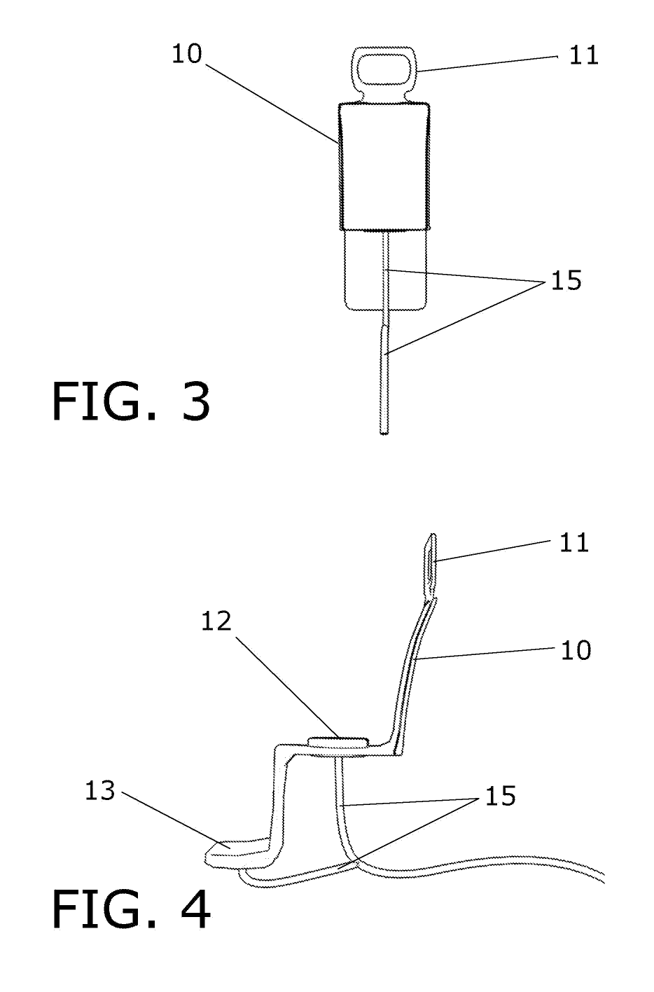

### DETAILED DESCRIPTION OF THE INVENTION

Referring now to the invention in more detail, the invention is directed to a wheelchair bathing attachment 10.

The first exemplary embodiment is comprised of a wheelchair bathing attachment 10, which provides four sections in an accordion fold, supporting the user's back, buttocks, lower legs, and feet in a sitting position on a wheelchair or scooter. A headrest 11 is also provided. Two small wash basins are provided: an upper basin 12 for the buttocks, and a lower basin 13 for the feet. Each wash basin provides a central drain 14 with a removable, flexible drain hose 15, enabling the user to drain the used water conveniently into a sink or toilet. The lower basin 13 is also capable of being inverted for easier draining. The attachment 10 is provided in a range of configurations and sizes to fit any existing wheelchair or scooter.

To use the first exemplary embodiment, the user must have a supply of warm water ready for easy transfer into the wash basins. The user then places the attachment 10 on the wheelchair or scooter in the conventional manner, attaches the drain hoses 15, and places the lower end of the drain hoses 15 in a sink or toilet to drain used water. The user may then undress and sit down on the attachment 10. The user bathes and rinses with the prepared supply of warm water, allowing used water to be collected in the upper wash basin 12 and lower wash basin 13, to be removed by the drain hoses 15.

The attachment 10 is preferably manufactured from flexible, durable materials which are waterproof, such as thermoplastic elastomer, plastic, foam rubber, and vinyl. The drain hoses 15 are preferably manufactured from a flexible, durable material, such as rubber or silicone.

Components, component sizes, and materials listed above are preferable, but artisans will recognize that alternate components and materials could be selected without altering the scope of the invention.

While the foregoing written description of the invention enables one of ordinary skill to make and use what is presently considered to be the best mode thereof, those of ordinary skill in the art will understand and appreciate the existence of variations, combinations, and equivalents of the specific embodiment, method, and examples herein. The invention should, therefore, not be limited by the above described embodiment, method, and examples, but by all embodiments and methods within the scope and spirit of the invention.

I claim:

1. A wheelchair bathing attachment, comprising:
a. a bathing attachment;
b. said bathing attachment being sized and configured to attach to a wheelchair and providing support for a user's back, buttocks, lower legs, and feet;
c. an upper basin;
d. said upper basin being positioned on a seat of the wheelchair and providing support for a user's buttocks;
e. a lower basin;
f. said lower basin being positioned on a footrest of the wheelchair and providing support for a user's feet;
g. said upper basin and said lower basin providing central drains;
h. said central drains being attached to removable drain hoses such that water is collected by the upper basin and the lower basin and drains through said central drains into said drain hoses.
